(19) United States
(12) Patent Application Publication
(10) Pub. No.: US 2011/0081608 A1
(43) Pub. Date: Apr. 7, 2011

(54) ELECTROPHOTOGRAPHIC TONER AND IMAGE FORMING APPARATUS

(76) Inventors: Shigenori Yaguchi, Numazu-shi (JP); Shinya Nakayama, Numazu-shi (JP); Hideyuki Santo, Numazu-shi (JP); Takahiro Honda, Numazu-shi (JP)

(21) Appl. No.: 12/893,450

(22) Filed: Sep. 29, 2010

(30) Foreign Application Priority Data
Oct. 2, 2009 (JP) 2009-230126
Oct. 8, 2009 (JP) 2009-234071
Aug. 31, 2010 (JP) 2010-193956

(51) Int. Cl. G03G 9/00; G03G 15/01

(52) U.S. Cl. 430/105; 399/223; 399/299; 399/252

(57) ABSTRACT

A transparent toner for electrophotographic image forming method forming an image on a recording medium with one or more chromatic toner and a transparent toner, including a thermoplastic resin; and a lubricant, wherein the transparent toner has a tangent loss (tan δ) determined by the following formula has a maximum peak value not less than 3 in a range of from 80 to 160° C.:

tangent loss (tan δ)=loss elastic modulus (G″) of the transparent toner/storage modulus (G′) thereof.

### BACKGROUND OF THE INVENTION

1. Field of the Invention

The present invention relates to a chromatic toner for visualizing an electrostatic latent image and a transparent toner forming a glossy image, which are formed on the surface of an image bearer, and to a developer and an image forming apparatus using the toners.

2. Description of the Background

Electrophotographic image forming methods used in image forming apparatuses such as laser printers and dry electrostatic copiers include a process of uniformly charging the surface of an image bearer such as photoconductive layers; a process of irradiating the surface of the image bearer to dissipate a charge thereon and forming an electric latent image; a process of attaching a fine powder having a charge, which is called a toner, to the latent image for visualizing the latent image to form a visible image; a process of transferring the visible image onto a recording medium such as transfer papers; a process of fixing the visible image onto the recording medium upon application of heat and pressure; and a process of cleaning any residual fine powder remaining untransferred on the surface of the image bearer.

Contemporary image forming apparatuses are now required to both fix toner images in an energy-efficient way as well as produce images at high speed, and the toner itself is required to have meltability at low temperature. Further, it is largely demanded that images have higher quality. In compliance with requirements for high-definition images such as photographic images, glossiness is imparted to the surface of a recording medium such as recording papers to form clear glossy images.

Japanese published unexamined applications Nos. 4-278967 (JP-H04-278967-A), 4-362960 (JP-H04-362960-A), and 9-200551 (JP-H09-200551-A) disclose methods of locating a transparent toner on a non-image area to lessen a difference of glossiness between a part having a chromatic toner and a part having no chromatic toner on a recording medium, or locating a transparent toner over the whole surface of a recording medium. Further, Japanese published unexamined application No. 5-158364 (JP-H05-158364-A) discloses an apparatus melting chromatic and transparent toners images formed on a recording medium upon application of heat with a fixer, and cooling and peeling them to form a high-gloss image on the whole surface of the recording medium.

These methods can provide uniform glossiness over the whole surface of a recording medium without localized differences of glossiness.

In the field of printing, UV varnish printing, varnishing, and PP lamination are typically made to make spot varnishing which makes a specific part high-gloss. Spot printing includes normal color printing and making a block to make the printing partially high-gloss with UV varnishing. A varnished part has high gloss and the other parts have low gloss, and the gloss difference therebetween is large, which is differentiated from normal printing. However, to achieve the same effect in offset printing a special block is needed, and moreover a certain volume is needed because this type of printing cannot accommodate variable data.

By contrast, if the electrophotographic image forming methods used in image forming apparatuses such as laser printers and dry electrostatic copiers can have such performances, they do not need a special block and can accommodate variable data.

As electrophotographic methods of forming different glosses on the same recording medium, Japanese published unexamined application No. 8-220821 (JP-H08-220821-A) discloses a method of controlling glossiness with a number-average molecular weight of a resin used in a toner, Japanese published unexamined application No. 2009-109926 (JP-2009-109926-A) discloses a method of fixing a chromatic toner, forming a transparent toner image, and lowering the fixing temperature to decrease gloss, and Japanese published unexamined application No. 4-338984 (JP-H04-338984-A) discloses a method of printing and fixing a glossy area firstly and printing and fixing a non-glossy area secondly. These methods can provide different glosses on the same recording medium, but as yet cannot provide glossiness close to photographic glossiness.

As mentioned above, various methods of controlling glossiness on a recording medium with a transparent toner are available.

Japanese published unexamined application No. 8-220821 (JP-H08-220821-A) discloses that a polyester resin having a number-average molecular weight of about 3,500 is used as a transparent toner, a polyester resin having a number-average molecular weight of about 10,000 is used as a chromatic toner, and the transparent toner has a melting point lower than that of the chromatic toner to increase the smoothness and glossiness of that part of the medium on which the transparent toner is fixed.

However, the transparent toner needs to have higher hot offset resistance than the chromatic toner because it is formed as the uppermost layer of an image and directly contacts a fixer, and the chromatic toner needs to have high cold offset resistance because a transparent toner image is formed on a chromatic toner image, resulting in a thick toner layer. A combination of a transparent toner having a low melting point and a chromatic toner having a high melting point is unstable.

A cross-linking monomer is typically used to widen a molecular weight distribution of a resin to prevent hot offset. However, although the cross-linking monomer can prevent hot offset, the resultant toner does not have fluidity because of elastic components, and deteriorates in its surface smoothness and glossiness.

In the method disclosed in Japanese published unexamined application No. 2009-109926 (JP-2009-109926-A), a melt viscosity of a toner in a fixing nip where a second image formed is larger than that when a first image is formed, and therefore, a transparent toner image does not fully melt when the second image is formed, resulting in deterioration of glossiness.

In the image forming method disclosed in Japanese published unexamined application No. 4-338984 (JP-H04-338984-A), it is disclosed that thermoplastic resins and thermosetting resins such as styrene-acrylic copolymers and polyester resins can be used as the transparent toner, but a specific toner configuration to be glossy is not disclosed.

For these reasons, a need exists for an image forming method forming different glosses on the same recording medium, and in particular forming a high-gloss part having nearly photographic gloss thereon.

### SUMMARY OF THE INVENTION

Accordingly, an object of the present invention is to provide a transparent toner and a chromatic toner having low-temperature fixability, capable of forming different glosses on a same recording medium, particularly forming a high-gloss part having nearly photographic gloss thereon.

Another object of the present invention is to provide an image forming apparatus using the transparent toner and the chromatic toner.

These objects and other objects of the present invention, either individually or collectively, have been satisfied by the discovery of a transparent toner for electrophotographic image forming method forming an image on a recording medium with one or more chromatic toner and a transparent toner, comprising:

a thermoplastic resin; and

a lubricant,

wherein the transparent toner has a tangent loss (tan δ) determined by the following formula has a maximum peak value not less than 3 in a range of from 80 to 160° C.:

tangent loss (tan δ)=loss elastic modulus (G″) of the transparent toner/storage modulus (G′) thereof.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic front view illustrating an embodiment of the image forming apparatus of the present invention;

FIG. 2 is a schematic front view illustrating another embodiment of the image forming apparatus of the present invention; and

FIG. 3 is a schematic front view illustrating a further embodiment of the image forming apparatus of the present invention; and

FIG. 4 is a diagram showing viscoelasticity of a toner having a tangent loss having a peak in a range of from 80 to 160° C.

### DETAILED DESCRIPTION OF THE INVENTION

The present invention provides a transparent toner and a chromatic toner having low-temperature fixability, capable of forming different glosses on a same recording medium, particularly forming a high-gloss part having nearly photographic gloss thereon. More Particularly, the present invention relates to a transparent toner for electrophotographic image forming method forming an image on a recording medium with one or more chromatic toner and a transparent toner, comprising:

a thermoplastic resin; and

a lubricant,

wherein the transparent toner has a tangent loss (tan δ) determined by the following formula has a maximum peak value not less than 3 in a range of from 80 to 160° C.:

tangent loss (tan δ)=loss elastic modulus (G″) of the transparent toner/storage modulus (G′) thereof.

The storage modulus of a transparent toner needs to lower rapidly at from comparatively a low temperature to have low temperature fixability and high glossiness.

The transparent toner lowering the storage modulus (G′) rapidly easily enters a recording paper having low surface smoothness and microscopic concavities and convexities of a chromatic toner, and has good extendability.

Meanwhile, in terms of hot offset resistance, the storage modulus (G′) needs to lower moderately after having a specific viscosity and keep the viscosity. Further, the loss elastic modulus (G″) needs not to lower so rapidly as the storage modulus (G′).

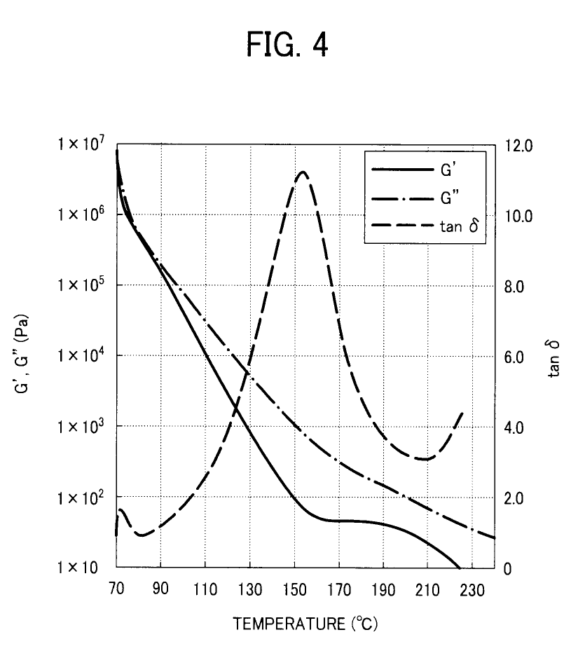

Unless the storage modulus (G′) rapidly lowers at a specific temperature and lowers moderately at another specific temperature, a tangent loss does not have a peak as shown in FIG. 4.

Only the toner having the above-mentioned properties has a peak of tangent loss, and the tangent loss (tan δ) has a maximum peak value not less than 3 in a range of from 80 to 160° C.

When lower than 80° C., the storage modulus (G′) of a toner lowers, resulting in deterioration of storage stability thereof and aggregation thereof when stored. Further, the toner has too low viscoelasticity at high temperature and deteriorates in hot offset resistance. When higher than 160° C., the toner deteriorates in low-temperature fixability.

When the maximum peak value is less than 3, the storage modulus (G′) does not lower so much, compared with a curve of the loss elastic modulus (G″), and the toner does not have sufficient low-temperature fixability and hot offset resistance.

The peak temperature and the maximum peak value of the tangent loss (tan δ) depend on the viscoelasticity of a resin, and a load to a resin in the process of preparing t a toner such as melting and kneading conditions can change the peak temperature and the maximum peak value.

When a crystalline polyester is combined, a softening point and the content thereof in a toner change the viscoelasticity of a toner, i.e., can change the peak temperature and the maximum peak value of the tangent loss (tan δ).

The tangent loss (tan δ) in the present invention is measured by measuring the viscoelasticity. 0.8 g of a toner is cast with a dice having a diameter of 20 mm at a pressure of 30 Mpa. The loss elastic modulus (G″), the storage modulus (G′) and the tangent loss (tan δ) were measured by Advanced Rheometric Expansion System from TA Instrument, USA with a parallel cone having a diameter of 20 mm under the following conditions:

Frequency: 1.0 Hz

Heating speed: 2.0° C./min

Distortion: 0.1% (automatic distortion control: allowable minimum stress 1.0 g/cm, allowable maximum stress 500 g/cm, maximum additional distortion 200% and distortion adjustment 200%)

Gap: in a force range of from 0 to 100 gm after setting a sample

When the storage modulus (G′) is 10 or less, the tangent loss (tan δ) is excluded.

The thermoplastic resin used in the transparent toner of the present invention preferably has a ratio (Mw/Mn) of a weight-average molecular weight (Mw) to a number-average molecular weight (Mn) not greater than 6. Particularly, a resin including many cross-linked monomers and having a wide molecular weight distribution of many branched molecules is not suitable for the present invention because of not imparting gloss to the resultant toner.

A linear polyester resin or a slightly crosslinked polyester resin is preferably used for a toner to have high gloss. The resin preferably has a ratio (Mw/Mn) not greater than 6, and more preferably not greater than 5. When greater than 6, the resultant toner has low gloss. The linear polyester resin may be plural linear polyester resins having different molecular weight from each other.

The number-average molecular weight and weight-average molecular weight of the binder resin is measured by a GPC measurer GPC-150C from Waters Corp. A column (KF801 to 807 from Shodex) is stabilized in a heat chamber having a temperature of 40° C.; THF is put into the column at a speed of 1 ml/min as a solvent; a sample having a concentration of from 0.05 to 0.6% by weight, is put into the column to measure a molecular weight distribution of the binder resin. From the molecular weight distribution thereof, the weight-average molecular weight and the number-average molecular weight of the binder resin are determined by using a calibration curve which is previously prepared using several polystyrene standard samples having a single distribution peak.

As the standard polystyrene samples for making the calibration curve, for example, the samples having a molecular weight of 6×10², 2.1×10³, 4×10³, 1.75×10⁴, 5.1×10⁴, 1.1×10⁵, 3.9×10⁵, 8.6×10⁵, 2×10⁶ and 48×10⁶ from Pressure Chemical Co. or Tosoh Corporation are used. It is preferable to use at least 10 standard polystyrene samples. In addition, an RI (refraction index) detector is used as the detector.

The image forming apparatus can produce images having sufficient gloss even by one-time fixation. In order to produce images having higher gloss, after a chromatic toner and a transparent toner are fixed on a recording medium, a chromatic toner is further fixed on the fixed toner. Namely, the one-time fixation produces a normal gloss image and two-time fixation produces a high gloss image.

The two-time fixation can provide sufficient calorie to a part a transparent toner is formed on, which has more toner than the other part a transparent toner is not formed on, and further increase surface smoothness so that the part a transparent toner is formed on can have high gloss.

The one-time fixation does not fix at low temperature and provides an enough calorie so as to maintain sufficient fixation strength. In the present invention, the transparent toner is formed on the chromatic toner and required to have higher releasability and hot offset resistance than the chromatic toner because of directly contacting a fixer. Further, the transparent toner needs to impart high glossiness to images.

Meanwhile, the glossiness of the chromatic toner can be selected in accordance with the purpose. When the chromatic toner has high gloss, the transparent toner is likely to have high gloss. They have a low gloss difference on a recording medium.

When a chromatic toner having low gloss is used, the gloss difference on a recording medium can be enlarged, but the resultant images are difficult have high gloss even when a transparent toner is formed thereon.

This is because the chromatic toner having low gloss includes a resin taking back the original form due to its viscoelasticity and has microscopic concavities and convexities on the surface after fixed.

As a whole, the chromatic toner may have a small ratio of Mw/Mn when the resultant image is required to have high glossiness, and a large ratio of Mw/Mn when required to have low glossiness.

When the chromatic toner has low gloss, a thick transparent toner layer covers concavities and convexities of the chromatic toner to make the resultant image have high gloss. A combination of the chromatic toner having low gloss and a transparent toner having high gloss, and an adjustment of the thickness of the transparent toner layer can freely form images having different glosses from low gloss to high gloss.

In the present invention, the transparent toner formed on the chromatic toner preferably has a thickness of form 1 to 15 μm after fixed. When less than 1 μm, the resultant image is difficult to have high gloss. When greater than 15 μm, the transparent toner is not fixed well and deteriorates in transparency, resulting in deterioration of color reproducibility of the chromatic toner.

A recording medium is cut by Microtome to measure the thickness of a toner layer.

The transparent toner of the present invention needs to include a lubricant. The transparent toner is required to have high hot offset resistance because of being located on the uppermost of an image, and can have good releasability from a fixer.

Specific examples of the lubricants include, but are not limited to, liquid paraffin, microcrystalline wax, natural paraffin, synthetic paraffin, polyolefin wax and their partially oxidized materials; aliphatic hydrocarbon lubricants such as fluorides and chlorides; animal oils such as beef fat and fish oil; plant oils such as palm oil, soy oil, canola oil, rice wax and carnauba wax; higher aliphatic alcohol and higher fatty acid lubricants such as Montan wax; metal soap lubricants such as fatty acid amide, fatty acid bisamide, zinc stearate, calcium stearate, magnesium stearate, aluminum stearate, zinc oleate, zinc palmitate, magnesium palmitate, zinc myristate, zinc laurate and zinc behenate; fatty acid ester lubricants; and polyvinylidenefluoride.

The lubricants can be used alone or in combination. The toner preferably includes the lubricant in an amount of from 0.1 to 15 parts by weight, more preferably from 1 to 7 parts by weight per 100 parts by weight of a binder resin included in the toner. The lubricant imparts hot offset resistance, fixation strength and high scratch resistance to a toner. The toner has low-temperature fixability when used in high-speed image forming apparatus. When less than 0.1 parts by weight, the offset tends to occur. When greater than 15 parts by weight, carrier spent tends to occur, resulting in deterioration of image quality.

The toner preferably includes the lubricant at the surface in an amount of from 0.01 to 1 parts by weight, more preferably from 0.01 to 0.3 parts by weight per 100 parts by weight of a binder resin included in the toner.

When the toner includes the lubricant at the surface, the lubricant directly contacts an image bearer to form a thin film on the surface thereof, which has effects for releasing the toner therefrom and preventing the toner from adhering thereto.

The transparent toner of the present invention has a tangent loss (tan δ) determined by the following formula, having a maximum peak value in a range of from 80 to 160° C.:

loss elastic modulus (G″) of the transparent toner/storage modulus (G′) thereof=tangent loss (tan δ).

A thermoplastic resin having the above-mentioned constitution can be used alone, and a crystalline polyester resin can be combined.

The combination of the crystalline polyester resin enables a toner to fix at lower temperature and further increase glossiness of the resultant images even at low temperature. The crystalline polyester resin makes crystal transformation at a glass transition temperature, and rapidly lowers its melt viscosity from solid state and develops fixability on a recording medium such as papers. The crystalline polyester resin preferably has a crystallinity index, i.e., a ratio of a softening point to an endothermic maximum peak temperature when measured by a DSC (softening point/endothermic maximum peak temperature) of form 0.6 to 1.5, and more preferably from 0.8 to 1.2. The content of the crystalline polyester resin is preferably from 1 to 35 parts by weight, and more preferably from 1 to 25 parts by weight per 100 parts by weight of a polyester resin. When the content of the crystalline polyester resin is too high, filming of the resultant toner over the surface of an image bearer such as photoreceptors tends to occur and storage stability thereof deteriorates, and further the transparency deteriorates.

When the toner includes fatty acid amide lubricants, the crystallization of the crystalline polyester is accelerated and the storage stability of the toner improved. Specific examples thereof include stearic amide, oleic amide, erucamide, ethylene-bisstearic amide.

The transparent toner and the chromatic toner may include a charge controlling agent.

Specific examples thereof include, but are not limited to, Nigrosine and its modified material, metal salts of fatty acids and their modified materials, onium salts such as phosphonium salts and their lake pigments, triphenylmethane dyes and their lake pigments, metal salts of higher fatty acids; diorganotinoxides such as dibutyltinoxide, dioctyltinoxide and dicyclohexyltinoxide; diorganotinborates such as dibutyltinborate, dioctyltinborate and dicyclohexyltinborate; organic metal complexes, chelate compounds, monoazo metal complexes, acetylacetone metal complexes, aromatic hydroxycarboxylic acids, metal complexes of aromatic dicarboxylic acids and quaternary ammonium salts. In addition, aromatic mono and polycarboxylic acids and their metal salts, anhydrides, esters and phenol derivatives such as bisphenol can be used. These can be used alone or in combination.

The toner preferably includes the charge controlling agent in an amount of from 0.1 to 10 parts by weight per 100 parts of the binder resin. The transparent toner preferably includes the white or transparent charge controlling agent because of being used as a colorant occasionally.

Further, the transparent and chromatic toners may include an external additive.

Specific examples thereof include abrasives such as silica, TEFLON (registered trademark) resin powder, polyvinylidene fluoride powder, cerium oxide powder, silicon carbide powder and strontium titanate powder; fluidity improvers such as titanium oxide powder and aluminum oxide powder; aggregation inhibitor; resin powder; and conductivity imparting agent such as zinc oxide powder, antimony oxide powder and tin oxide powder. In addition, white particulate materials and black particulate materials can be used as developability improvers. These can be used alone or in combination, and can protect the toner from stress when stirred.

When a two-component developing method is used, magnetic particulate materials used as a magnetic carrier include magnetite, spinel ferrites such as gamma iron oxide, spinel ferrites including one or more metals except for iron such as Mn, Ni, Zn, Mg and Cu, magnetoplumbite ferrites such as barium ferrite, and particulate iron or alloy having an oxidized surface layer. The magnetic particulate material may have a granular, spherical or acicular form. Particularly, ferromagnetic particulate materials such as iron is preferably used when high magnetization is required. In consideration of chemical stability, magnetite, spinel ferrites including gamma iron oxide and magnetoplumbite ferrites such as barium ferrite are preferably used. A resin carrier having a desired magnetization can be used by selecting the ferromagnetic particulate materials and the content thereof. The carrier preferably has a magnetization of from 30 to 150 emu/g at 1,000 Oe.

The resin carrier is formed by spraying a melted and kneaded material including a magnetic particulate material and an insulative binder resin. Alternatively, a monomer or a prepolymer is reacted and cross-linked in an aqueous medium under the presence of a magnetic particulate material to form a resin carrier in which the magnetic particulate material is dispersed in a condensed binder.

A positively or negatively chargeable particulate material or an electroconductive particulate material is anchored, or a resin is coated on the surface of the magnetic carrier to control its chargeability.

The magnetic carrier is coated with a silicone resin, an acrylic resin, an epoxy resin, a fluorine-containing resin, etc., and further coated with the positively or negatively chargeable particulate material or an electroconductive particulate material. The silicone resin and the acrylic resin are preferably used.

The toner preferably includes a magnetic carrier in an amount of from 2 to 10% by weight.

The toner preferably has a weight-average particle diameter of from 2 to 25 μm.

The particle diameter of a toner is measured by various methods, e.g., a sample toner is placed in an electrolyte including a surfactant and dispersed by an ultrasonic disperser for 1 min to form 50,000 pieces of the toner, which are measured by COULTER COUNTER Multisizer III.

The transparent toner and chromatic toner of the present invention are prepared by mixing a binder resin and a lubricant, and optionally a colorant, a charge controlling agent and an additive by a mixer such as HENSCHEL MEIXER and SUPER MIXER to prepare a mixture, melting and kneading the mixture upon application of heat by a heat melting kneader such as a heat roll and an extruder to prepare a kneaded mixture; cooling the kneaded mixture to be solidified to prepare a solid mixture; pulverizing the solid mixture to prepare a pulverized mixture; and classifying the pulverized mixture. The pulverization methods include a jet mill method including a toner in a high-speed stream and crashing the toner into a collision plate; an inter-particles collision method crashing the toners each other in a stream; and a mechanical pulverization method feeding a toner into a narrow gap between rotors rotating at high speed.

The toner can be prepared by solution suspension methods dissolving or dispersing toner constituents in an organic solvent to prepare an oil phase, dispersing the oil phase in an aqueous medium, de-solventing, filtering, washing and drying.

The image developer of the image forming apparatus of the present invention is selected according to a travel speed of the image bearer. High-speed printers in which the image bearer has a high travel speed use plural developing magnetic rolls to increase a developing area and a developing time.

The plural developing magnetic rolls has higher developability than a single developing roll, and not only improve printability of an image having an large area and print quality, but also decreases the content of the toner and a rotation speed of the developing roll. This prevents a toner from scattering and spending on a carrier to make a two-component developer have a longer life.

A combination of the developing method and the toner can provide an image forming apparatus producing quality images and stably attaching a toner to both image parts and solid image parts without defective transfer due to variation of image density.

Fur brushes, magnetic brushes and blades are known to clean an image bearer.

Hereinafter, an image forming apparatus used for evaluating the transparent toner of the present invention, a chromatic toner and the transparent toner, and a two-component developer formed of a chromatic toner and a carrier will be explained.

### <Image Forming Method 1>

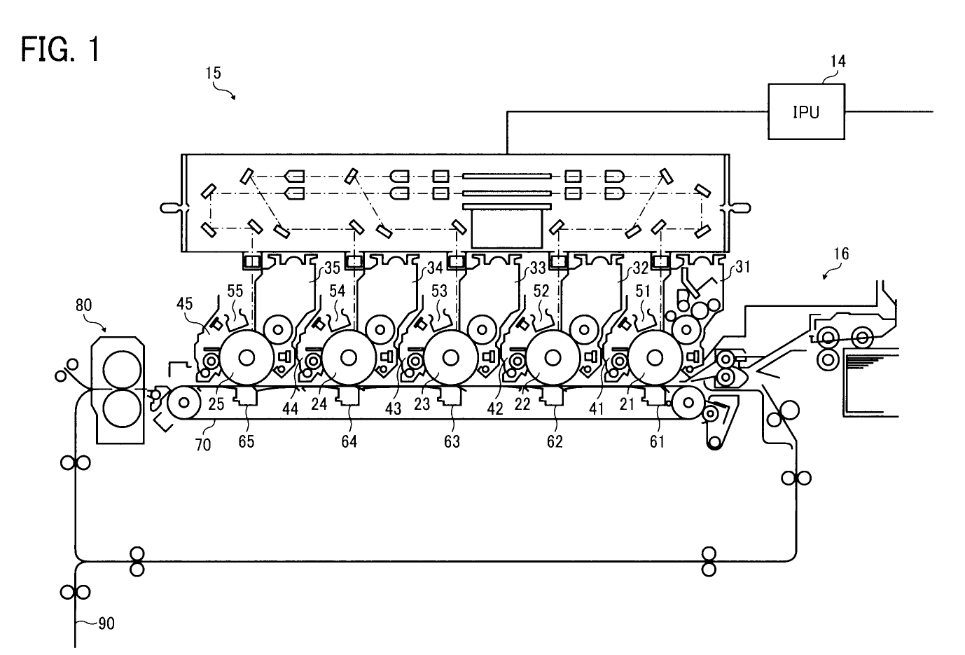

FIG. 1 is a schematic front view illustrating an embodiment of the image forming apparatus of the present invention. First, an image forming method 1 will be explained.

An image data transferred to an image processing unit (hereinafter referred to as “IPU”) (14) in converted to five color image signals, i.e., Y (yellow), M (magenta), C (cyan), Bk (black) and transparent color image signals. The Y, M, C, Bk and transparent color image signals are transferred to a writing unit (15). The writing unit (15) modulates the Y, M, C, Bk and transparent color image signals and to form laser beams thereof and sequentially scans photoreceptors (21, 22, 23, 24 and 25) therewith after they are charged by chargers 51, 52, 53, 54 and 55 to form electrostatic latent images on the respective photoreceptors. In this embodiment, the photoreceptor drum (21) is for Bk color image, the photoreceptor drum (22) is for Y color image, the photoreceptor drum (23) is for M color image, the photoreceptor drum (24) is for C color image and the photoreceptor drum (25) is for transparent color image.

Next, developing units (31, 32, 33, 34 and 35) form toner images having each color on the photoreceptor drums (21, 22, 23, 24 and 25), respectively. A transfer paper fed from a paper feeder (16) and on a transfer belt (70), and transfer chargers (61, 62, 63, 64 and 65) sequentially transfer the toner images on the photoreceptor drums (21, 22, 23, 24 and 25) onto the transfer paper.

After the transfer process, the transfer paper is fed to a fixing unit (80), where the toner image is fixed on the transfer paper.

After the fixing process, toners remaining on the photoreceptor drums (21, 22, 23, 24 and 25) are removed by cleaners (41, 42, 43, 44 and 45), respectively.

### <Image Forming Method 2>

Next, an image forming method 2 producing images partially having high gloss will be explained.

As in the image forming method 1, an image data transferred to an image processing unit (hereinafter referred to as “IPU”) (14) in converted to five color image signals, i.e., Y (yellow), M (magenta), C (cyan), Bk (black) and transparent color image signals.

Next, the IPU makes a first image formation forming an image partially having high gloss. Each highly glossy part of the Y, M, C, Bk and transparent color image signals is transferred to a writing unit (15). The writing unit (15) modulates the Y, M, C, Bk and transparent color image signals and to form laser beams thereof and sequentially scans photoreceptors (21, 22, 23, 24 and 25) therewith after they are charged by chargers 51, 52, 53, 54 and 55 to form electrostatic latent images on the respective photoreceptors. In this embodiment, the photoreceptor drum (21) is for Bk color image, the photoreceptor drum (22) is for Y color image, the photoreceptor drum (23) is for M color image, the photoreceptor drum (24) is for C color image and the photoreceptor drum (25) is for transparent color image.

Next, developing units (31, 32, 33, 34 and 35) form toner images having each color on the photoreceptor drums (21, 22, 23, 24 and 25), respectively. A transfer paper fed from a paper feeder (16) and on a transfer belt (70), and transfer chargers (61, 62, 63, 64 and 65) sequentially transfer the toner images on the photoreceptor drums (21, 22, 23, 24 and 25) onto the transfer paper.

After the transfer process, the transfer paper is fed to a fixing unit (80), where the toner image is fixed on the transfer paper.

After the fixing process, toners remaining on the photoreceptor drums (21, 22, 23, 24 and 25) are removed by cleaners (41, 42, 43, 44 and 45), respectively.

The transfer paper the toner image is fixed on is transferred to image processing unit (14). In the second image formation, each normally glossy part of the Y, M, C, Bk and transparent color image signals without the first image formation is transferred by an image computing process to a writing unit (15).

The Y, M, C and Bk images except for the transparent images are written on the respective photoreceptor drums (21, 22, 23 and 24). These are developed, transferred and fixed as in the first image formation.

The transparent image can be formed on a part of a printing paper, where the image density is low, the whole of the printing paper or only the image part, depending on the image computing process.

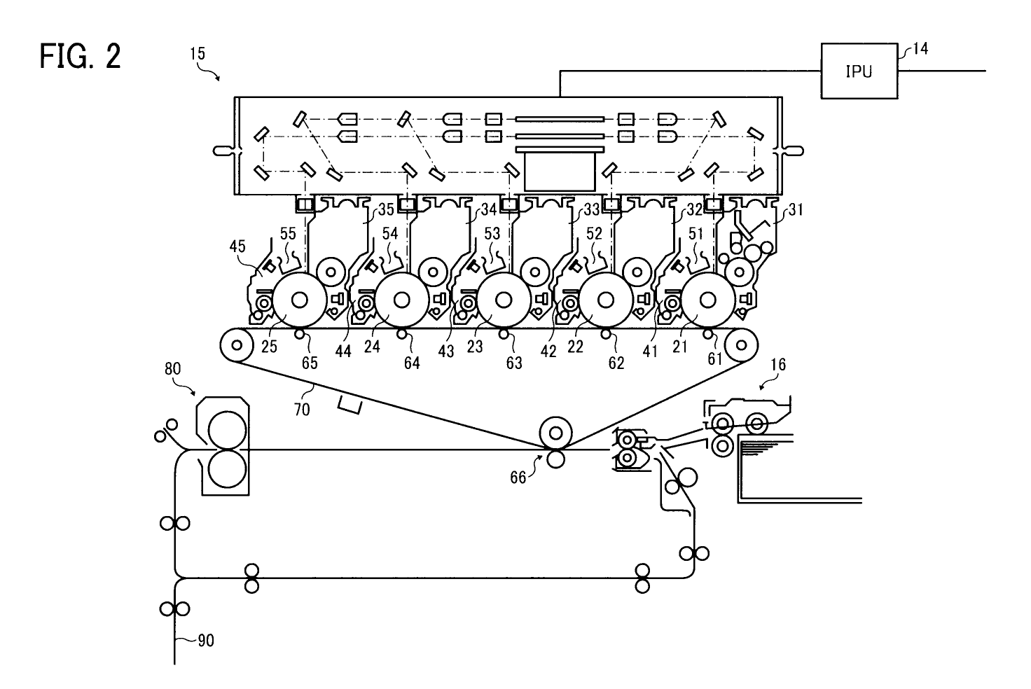

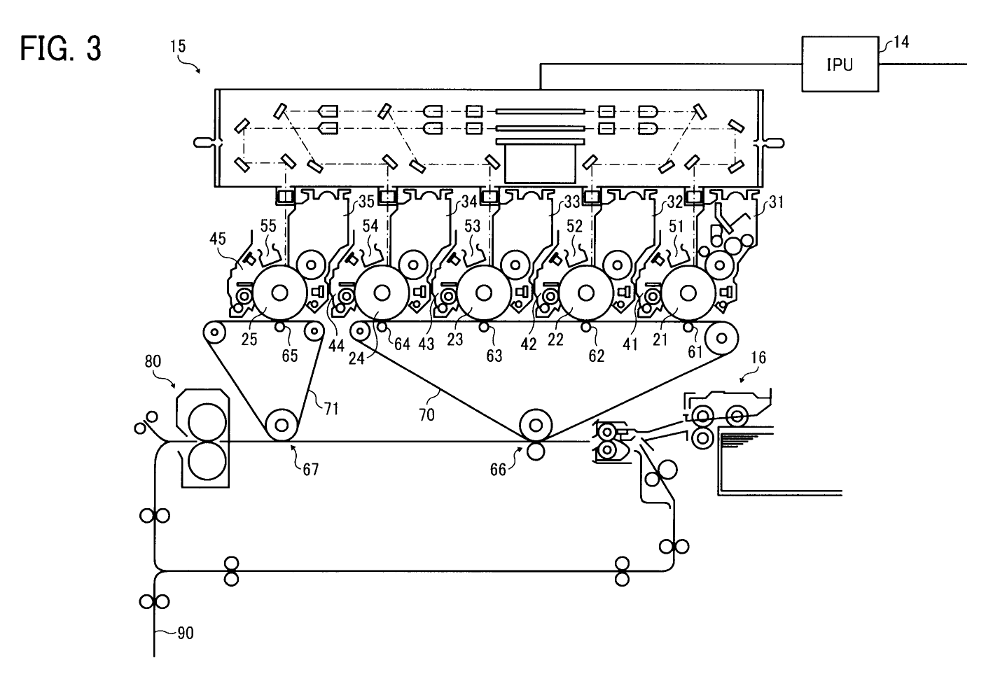

In the image forming apparatus in FIG. 2 and an image forming method using the apparatus, as in FIG. 1, toner images formed on photoreceptor drums (21, 22, 23, 24 and 25) are once transferred onto a transfer drum, transferred onto a transfer paper by a second transferer (66), and fixed thereon by a fixer (80). The image forming methods 1 and 2 can be used. When the transparent toner layer on the transfer drum is thick, the second transfer is difficult to make and another transfer drum can be used as in FIG. 3.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Preparation Example of Masterbatch 1

50 parts of carbon black (Regal 400R from Cabot Corp.) and 50 parts of a polyester resin (RS801 from Sanyo Chemical Industries, Ltd.) were mixed in 30 parts of water by HENSCHEL MIXER (from Nippon Coke & Engineering Co., Ltd.) to prepare a mixture. The mixture was kneaded by a two-roll mill at 160° C. for 50 min to prepare a kneaded mixture, the kneaded mixture was expanded upon application of pressure and cooled to prepare a solidified mixture, and the solidified mixture was pulverized to prepare a black masterbatch 1. The procedure for preparation of the black masterbatch 1 was repeated to prepare a magenta masterbatch 1, a cyan masterbatch 1 and a yellow masterbatch 1 except for replacing the carbon black with C.I. Pigment Red 269, C.I. Pigment Blue 15:3 and C.I. Pigment Yellow 155, respectively.

### Production Example of Transparent Toner 1

| | |
|---|---|
| Polyester Resin | 100 parts by weight |
| (Tg: 67.5° C., Mw: 18700, Mn: 4900, Acid Value: | |
| 6.6 mgKOH/g, Loss Tangent Peak Temperature: | |
| 156.5° C.) | |
| Carnauba wax | 5 parts by weight |
| (Carnauba Wax No. 1, made by Cerarica Noda | |
| Co., Ltd.) | |

After the above-mentioned toner raw materials had been preliminarily mixed by using a Henschel Mixer (FM20B, made by Nippon Coke & Engineering. Co., Ltd.), the resulting mixture was melt-kneaded at a temperature in a range from 100 to 130° C. by a twin-screw kneader (PCM-30, made by Ikegai Corporation). After having been cooled to room temperature, the resulting kneaded matter was coarsely pulverized into 200 to 300 μm by using a hummer mill. Next, by using a ultrasonic jet pulverizer Labojet (made by Nippon Pneumatic Mfg. Co., Ltd.), this was finely pulverized, while the pulverizing air pressure was adjusted on demand so as to have a weight average particle size of 5.2±0.3 μm, and was then classified by a stream classifier (MDS-I, made by Nippon Pneumatic Mfg. Co., Ltd.), with the louver opening being adjusted on demand, so as to have a weight average particle size in a range from 6.0±0.2 μm and a ratio of weight average particle size/number average particle size of 1.20 or less, so that toner base particles were obtained. Next, to 100 parts by mass of the toner base particles were added 1.0 part by weight of an additive (HDK-2000, made by Clariant) and 1.0 part by weight of an additive (H05TD, made by Clariant), and they were stirred and mixed with one another by a Henschel mixer so that a transparent toner 1 was produced.

### Production Example of Transparent Toner 2

| | |
|---|---|
| Polyester resin | 100 parts by weight |
| (Tg: 64° C., Mw: 15300, Mn: 3800, Acid Value: | |
| 7 mgKOH/g, Loss Tangent Peak Temperature: | |
| 143.7° C.) | |
| Crystalline polyester resin (Softening point: | 10 parts by weight |
| 111° C.) | |
| Carnauba wax | 5 parts by weight |
| (Carnauba Wax No. 1, made by Cerarica Noda Co., | |
| Ltd.) | |

The same processes as those of the transparent toner 1 were carried out except that the above-mentioned toner raw materials were used so that a transparent toner 2 was produced.

### Production Example of Transparent Toner 3

| | |
|---|---|
| Polyester resin | 100 parts by weight |
| (Tg: 59° C., Mw: 10800, Mn: 2800, Acid Value: | |
| 8 mgKOH/g, Loss Tangent Peak Temperature: | |
| 129.6° C.) | |
| Crystalline polyester resin (Softening point: | 30 parts by weight |
| 77° C.) | |
| Carnauba wax | 5 parts by weight |
| (Carnauba Wax No. 1, made by Cerarica Noda | |
| Co., Ltd.) | |
| Ethylene-bis-stearic acid amide | 2 parts by weight |
| (EB-P, made by Kao Corporation) | |

The same processes as those of the transparent toner 1 were carried out except that the above-mentioned toner raw materials were used so that a transparent toner 3 was produced.

### Production Example of Transparent Toner 4

First, 100 parts of water, 10 parts of an aqueous dispersion solution of a vinyl-based resin (copolymer of styrene-methacrylic acid-butyl acrylate-sodium salt of an adduct of a sulfuric ester with ethyleneoxide methacrylate) (made by Sanyo Chemical Industries, Ltd., solid components: 20%), 20 parts of a 50% aqueous solution of dodecyldiphenylether sodium disulfonate (ELEMINOL MON-7, made by Sanyo Chemical Industries, Ltd., solid components: 20%), 40 parts of a 1% aqueous solution of carboxymethylcellulose serving as a polymer protective colloid (Cellogen ESH, made by Sanyo Chemical Industries, Ltd.), and 15 parts of ethyl acetate were mixed and stirred so that a solution having a milky white color was obtained. This was used as an aqueous phase.

To a container equipped with a stirring bar and a thermometer, 230 parts of a polyester resin (Tg: 59° C., Mw: 10800, Mn: 2800, Acid Value: 8 mgKOH/g, Loss Tangent Peak Temperature: 129.6° C.), 40 parts of a crystalline polyester resin (softening point: 92° C.), 40 parts of carnauba wax and 200 parts of ethyl acetate were loaded, and they were heated to 80° C. under stirring, and after having been maintained at 80° C. for 5 hours, the mixture was cooled to 30° C. over 1 hour, and by using a bead mill (Ultra Visco Mill made by AIMEX Co., Ltd.) under the following conditions: liquid feeding speed of 1.2 Kg/hr, peripheral disc speed of 10 m/sec, an amount of filling zirconia beads having 0.5 mm diameter of 80% by volume, and the number of passes of 5 times, the wax was dispersed and a wax dispersion solution was obtained.

Next, to a container equipped with a stirring bar and a thermometer were loaded 510 parts of the dissolved matter, 420 parts of the polyester resin, 100 parts of the crystalline polyester resin (softening point 92° C.) and 100 parts of ethyl acetate, and by using the bead mill, they were stirred under the following conditions: liquid feeding speed of 1.2 Kg/hr, peripheral disc speed of 10 m/sec, an amount of filling zirconia beads having 0.5 mm diameter of 80% by volume, and the number of passes of 5 times so that a dispersion solution was obtained. This was used for a pigment-wax dispersion solution.

Next, 1250 parts of the aqueous phase, 1130 parts of the wax dispersion solution, 1 part of isobutyl alcohol, 7 parts of isophoronediamine and 5 parts of an emulsion stabilizer UCAT660M (made by Sanyo Chemical Industries, Ltd.) were put into a container, and they were mixed by a TK-type homomixer (made by PRIMIX Corporation) at 9,000 rpm for 30 minutes under an ambient temperature of 28° C. so that an aqueous medium dispersion solution was obtained.

Thereafter, the aqueous medium dispersion solution was heated to 58° C., and it was further dispersed and mixed by using the TK-type homomixer at a rotation speed of 1,500 rpm for 1 hour so that an emulsified slurry was obtained.

The above-mentioned emulsified slurry was loaded into a container equipped with a stirring bar and a thermometer, and after having been subjected to a desolvent process at 35° C. for 10 hours, the slurry was matured at 45° C. for 12 hours so that a dispersion solution from which the organic solvent had been distilled off was obtained. After 100 parts of the dispersion solution had been filtered under reduced pressure, 300 parts of ion exchange water was added to the filtered cake, and after having been stirred by using the TK-type homomixer at a rotation speed of 6,000 rpm for 15 minutes, the mixture was filtered under reduced pressure. Thereafter, 100 parts of a 10% aqueous solution of sodium hydroxide was added to the filtered cake, and after having been stirred by the TK-type homomixer at a rotation speed of 6,000 rpm for 15 minutes, the mixture was filtered under reduced pressure. Thereafter, 100 parts of a 10% hydrochloric acid solution was added to the filtered cake, and after having been stirred by the TK-type homomixer at a rotation speed of 6,000 rpm for 15 minutes, the mixture was filtered under reduced pressure. To the filtered cake was then added 500 parts of ion exchange water, and after having been stirred by the TK-type homomixer at a rotation speed of 6,000 rpm for 30 minutes, the mixture was filtered under reduced pressure so that a filtered cake was obtained.

The filtered cake was dried by an air dryer at 40° C. for 24 hours, and sieved by a mesh having an opening of 75 μm to prepare toner base particles, which had a weight average particle size of 5.2 μm and a ratio of weight average particle size/number average particle size of 1.14.

Next, to 100 parts by mass of the toner base particles were added 1.0 part by weight of an additive (HDK-2000, made by Clariant) and 1.0 part by weight of an additive (H05TD, made by Clariant), and they were stirred and mixed with one another by a Henschel mixer so that a transparent toner 4 was produced.

### Production Example of Transparent Toner 5

First, 100 parts of water, 10 parts of an aqueous dispersion solution of a vinyl-based resin (copolymer of styrene-methacrylic acid-butyl acrylate-sodium salt of an adduct of a sulfuric ester with ethyleneoxide methacrylate) (made by Sanyo Chemical Industries, Ltd., solid components: 20%), 20 parts of a 50% aqueous solution of dodecyldiphenylether sodium disulfonate (ELEMINOL MON-7, made by Sanyo Chemical Industries, Ltd., solid components: 20%), 40 parts of a 1% aqueous solution of carboxymethylcellulose serving as a polymer protective colloid (Cellogen BSH, made by Sanyo Chemical Industries, Ltd.), and 15 parts of ethyl acetate were mixed and stirred so that a solution having a milky white color was obtained. This was used as an aqueous phase.

To a container equipped with a stirring bar and a thermometer, 250 parts of a polyester resin (Tg: 64° C., Mw: 15300, Mn: 3800, Acid Value: 7 mgKOH/g, Loss Tangent Peak Temperature: 143.7° C.), 40 parts of carnauba wax (Carnauba Wax No. 1, made by Cerarica Noda Co., Ltd.) and 200 parts of ethyl acetate were loaded, and they were heated to 80° C. under stirring, and after having been maintained at 80° C. for 5 hours, the mixture was cooled to 30° C. over 1 hour, and by using a bead mill (Ultra Visco Mill made by AIMEX Co., Ltd.) under the following conditions: liquid feeding speed of 1.2 Kg/hr, peripheral disc speed of 10 m/sec, an amount of filling zirconia beads having 0.5 mm diameter of 80% by volume, and the number of passes of 5 times, the wax was dispersed and a wax dispersion solution was obtained.

Next, to a container equipped with a stirring bar and a thermometer were loaded 490 parts of the dissolved matter, 520 parts of the polyester resin and 100 parts of ethyl acetate, and by using the bead mill, they were stirred under the following conditions: liquid feeding speed of 1.2 Kg/hr, peripheral disc speed of 10 m/sec, an amount of filling zirconia beads having 0.5 mm diameter of 80% by volume, and the number of passes of 5 times so that a dispersion solution was obtained. This was used for a pigment-wax dispersion solution.

Next, 1250 parts of the aqueous phase, 1110 parts of the wax dispersion solution, 130 parts of a 50% ethyl acetate solution of a prepolymer (number average molecular weight: 6500, Tg: 55° C., content of isolated isocyanate: 1.5% by weight, made by Sanyo Chemical Industries, Ltd.), 1 part of isobutyl alcohol, 7 parts of isophoronediamine and 5 parts of an emulsion stabilizer UCAT660M (made by Sanyo Chemical Industries, Ltd.) were put into a container, and they were mixed by a TK-type homomixer (made by PRIMIX Corporation) at 9,000 rpm for 30 minutes under an ambient temperature of 28° C. so that an aqueous medium dispersion solution was obtained.

Thereafter, the aqueous medium dispersion solution was heated to 58° C., and it was further dispersed and mixed by using the TK-type homomixer at a rotation speed of 1,500 rpm for 1 hour so that an emulsified slurry was obtained.

The above-mentioned emulsified slurry was loaded into a container equipped with a stirring bar and a thermometer, and after having been subjected to a desolvent process at 35° C. for 10 hours, the slurry was matured at 45° C. for 12 hours so that a dispersion solution from which the organic solvent had been distilled off was obtained. After 100 parts of the dispersion solution had been filtered under reduced pressure, 300 parts of ion exchange water was added to the filtered cake, and after having been stirred by using the TK-type homomixer at a rotation speed of 6,000 rpm for 15 minutes, the mixture was filtered under reduced pressure. Thereafter, 100 parts of a 10% aqueous solution of sodium hydroxide was added to the filtered cake, and after having been stirred by the TK-type homomixer at a rotation speed of 6,000 rpm for 15 minutes, the mixture was filtered under reduced pressure. Thereafter, 100 parts of a 10% hydrochloric acid solution was added to the filtered cake, and after having been stirred by the TK-type homomixer at a rotation speed of 6,000 rpm for 15 minutes, the mixture was filtered under reduced pressure. To the filtered cake was then added 500 parts of ion exchange water, and after having been stirred by the TK-type homomixer at a rotation speed of 6,000 rpm for 30 minutes, the mixture was filtered under reduced pressure so that a filtered cake was obtained.

The filtered cake was dried by an air dryer at 40° C. for 24 hours, and sieved by a mesh having an opening of 75 μm to prepare toner base particles, which had a weight average particle size of 5.2 μm and a ratio of weight average particle size/number average particle size of 1.14.

Next, to 100 parts by mass of the toner base particles were added 1.0 part by weight of an additive (HDK-2000, made by Clariant) and 1.0 part by weight of an additive (H05TD, made by Clariant), and this was stirred and mixed with one another by a Henschel mixer so that a transparent toner 5 was produced.

### Production Example of Transparent Toner 6

| | |
|---|---|
| Polyester resin | 100 parts by weight |
| (Tg: 63° C., Mw: 113000, Mn: 3700, Acid Value: | |
| 6.6 mgKOH/g, Loss | |
| Tangent Peak Temperature: 173.5° C.) | |
| Carnauba wax | 5 parts by weight |
| (Carnauba Wax No. 1, made by Cerarica Noda | |
| Co., Ltd.) | |

The same processes as those of the transparent toner 1 were carried out except that the above-mentioned toner raw materials were used so that a transparent toner 6 was produced.

### Production Example of Transparent Toner 7

| | |
|---|---|
| Polyester resin | 100 parts by weight |
| (Tg: 59° C., Mw: 10800, Mn: 2800, Acid Value: | |
| 8 mgKOH/g, Loss Tangent Peak Temperature: | |
| 129.6° C.) | |
| Crystalline polyester resin (Softening point: | 30 parts by weight |
| 70° C.) | |
| Carnauba wax | 5 parts by weight |
| (Carnauba Wax No. 1, made by Cerarica Noda | |
| Co., Ltd.) | |
| Ethylene-bis-stearic acid amide | 2 parts by weight |
| (EB-P, made by Kao Corporation) | |

The same processes as those of the transparent toner 1 were carried out except that the above-mentioned toner raw materials were used so that a transparent toner 7 was produced.

### Production Example of Transparent Toner 8

| | |
|---|---|
| Polyester resin | 100 parts by weight |
| (Tg: 53° C., Mw: 12000, Mn: 2900, Acid Value: | |
| 9.7 mgKOH/g, Loss | |
| Tangent Peak Temperature: 123° C.) | |
| Carnauba wax | 5 parts by weight |
| (Carnauba Wax No. 1, made by Cerarica Noda | |
| Co., Ltd.) | |

The same processes as those of the transparent toner 1 were carried out except that the above-mentioned toner raw materials were used so that a transparent toner 8 was produced.

### Production Example of Transparent Toner 9

| | |
|---|---|
| Polyester resin | 100 parts by weight |
| (Tg: 67.5° C., Mw: 18700, Mn: 4900, Acid | |
| Value: 6.6 mgKOH/g, Loss Tangent Peak | |
| Temperature: 156.5° C.) | |
| Crystalline polyester resin (Softening point: | 30 parts by weight |
| 111° C.) | |
| Carnauba wax | 5 parts by weight |
| (Carnauba Wax No. 1, made by Cerarica Noda | |
| Co., Ltd.) | |
| Ethylene-bis-stearic acid amide | 2 parts by weight |
| (EB-P, made by Kao Corporation) | |

The same processes as those of the transparent toner 1 were carried out except that the above-mentioned toner raw materials were used so that a transparent toner 9 was produced.

### Production Example of Transparent Toner 10

| | |
|---|---|
| Polyester resin (same as that of transparent toner 2) | 100 parts by weight |
| (Tg: 64° C., Mw: 15300, Mn: 3800, Acid Value: | |
| 7 mgKOH/g, Loss Tangent Peak Temperature: | |
| 143.7° C.) | |
| Crystalline polyester resin (Softening point: | 10 parts by weight |
| 111° C.) (same as that of transparent toner 2) | |
| Carnauba wax (same as that of transparent toner 2) | 5 parts by weight |
| (Carnauba Wax No. 1, made by Cerarica Noda Co., | |
| Ltd.) | |

The same processes as those of the transparent toner 2 were carried out except that to the above-mentioned toner raw materials was further added the following material so that a transparent toner 10 was produced.

Ethylene-bis-stearic acid amide 2 parts by weight
(EB-P, made by Kao Corporation)

### Production Example of Transparent Toner 11

The same processes as those of transparent toner 10 were carried out except that ethylene-bis-stearic acid amide (EB-P, made by Kao Corporation) was changed to 2 parts by weight of stearic acid amide (Fatty Acid Amide S, made by Kao Corporation); thus, a transparent toner 11 was produced.

### Production Example of Transparent Toner 12

The same processes as those of transparent toner 10 were carried out except that ethylene-bis-stearic acid amide (EB-P, made by Kao Corporation) was changed to stearic acid amide (Fatty Acid Amide O-S, made by Kao Corporation) so that a transparent toner 12 was produced.

### Production Example of Transparent Toner 13

| | |
|---|---|
| Polyester resin | 100 parts by weight |
| (Tg: 69° C., Mw: 23000, Mn: 5500, Acid Value: | |
| 2.7 mgKOH/g, Loss | |
| Tangent Peak Temperature: 164° C.) | |
| Carnauba wax | 5 parts by weight |
| (Carnauba Wax No. 1, made by Cerarica Noda Co., | |
| Ltd.) | |

The same processes as those of the transparent toner 1 were carried out except that the above-mentioned toner raw materials were used so that a transparent toner 13 was produced.

### Production Example of Transparent Toner 14

| | |
|---|---|
| Polyester resin | 100 parts by weight |
| (Tg: 58° C., Mw: 16200, Mn: 3300, Acid Value: | |
| 8.3 mgKOH/g, Loss Tangent Peak Temperature: | |
| 148° C.) | |
| Carnauba wax | 5 parts by weight |
| (Carnauba Wax No. 1, made by Cerarica Noda | |
| Co., Ltd.) | |

The same processes as those of the transparent toner 1 were carried out except that the above-mentioned toner raw materials were used so that a transparent toner 14 was produced.

### Production Example of Color Toner 1

| | |
|---|---|
| Polyester resin | 92 parts by weight |
| (Tg: 63° C., Mw: 113000, Mn: 3700, Acid Value: | |
| 6.6 mgKOH/g, Loss Tangent Peak Temperature: | |
| 173.5° C.) | |
| Carnauba wax | 4 parts by weight |
| (Carnauba Wax No. 1, made by Cerarica Noda Co., | |
| Ltd.) | |
| Black master batch 1 | 16 parts by weight |

The same processes as those of the transparent toner 1 were carried out except that the above-mentioned toner raw materials were used so that a black toner 1 was produced.

Moreover, the same processes as those described above were carried out except that in place of a black master batch 1, a magenta master batch 1, a cyan master batch 1 and a yellow master batch 1 were respectively used so that a magenta toner 1, a cyan toner 1 and a yellow toner 1 were manufactured, and a color toner 1 including the black toner 1, the magenta toner 1, the cyan toner 1 and the yellow toner 1 was produced.

### Production Example of Color Toner 2

First, 100 parts of water, 10 parts of an aqueous dispersion solution of a vinyl-based resin (copolymer of styrene-methacrylic acid-butyl acrylate-sodium salt of an adduct of a sulfuric ester with ethyleneoxide methacrylate) (made by Sanyo Chemical Industries, Ltd., solid components: 20%), 20 parts of a 50% aqueous solution of dodecyldiphenylether sodium disulfonate (ELEMINOL MON-7, made by Sanyo Chemical Industries, Ltd.), 40 parts of a 1% aqueous solution of carboxymethylcellulose serving as a polymer protective colloid (Cellogen BSH, made by Sanyo Chemical Industries, Ltd.) and 15 parts of ethyl acetate were mixed and stirred so that a solution having a milky white color was obtained. This was used as an aqueous phase.

To a four-neck flask equipped with a nitrogen introducing pipe, a dehydration pipe, a stirring device and a thermocouple were added 400 g of a 50% ethyl acetate solution (number average molecular weight: 6500, weight average molecular weight: 18000, Tg: 55° C., content of isolated isocyanate: 1.5% by weight, made by Sanyo Chemical Industries, Ltd.) of a prepolymer (a reaction product between a condensation product of a bisphenol A propyleneoxide adduct, a bisphenol A ethyleneoxide adduct, adipic acid and terephthalic acid, and isophoronediisocyanate), 100 g of a condensation product (number average molecular weight: 800) between a bisphenol A polypropyleneoxide adduct and adipic acid, 20 g of isophorone diamine and 50 g of ethyl acetate, and heated to 100° C. while being stirred under a nitrogen atmosphere, and after having been allowed to react with one another for 5 hours, ethyl acetate was distilled off under reduced pressure so that a modified polyester resin 1 having a urethane and/or urea group was obtained. This resin had a softening point of 104° C., a Tg of 60° C., an acid value of 18 KOHmg/g, and a hydroxyl group value of 45 KOHmg/g.

Next, to a container equipped with a stirring bar and a thermometer were loaded 500 parts of the modified polyester resin 1 having a urethane and/or urea group, 40 parts of carnauba wax and 200 parts of ethyl acetate, and they were heated to 80° C. under stirring, and after having been maintained at 80° C. for 5 hours, the mixture was cooled to 30° C. over 1 hour, and by using a bead mill (Ultra Visco Mill made by AIMEX Co., Ltd.) under the following conditions: liquid feeding speed of 1.2 Kg/hr, peripheral disc speed of 10 m/sec, an amount of filling zirconia beads having 0.5 mm diameter of 80% by volume, and the number of passes of 5 times, the wax was dispersed and a wax dispersion solution was obtained. Next, to a container equipped with a stirring bar and a thermometer were loaded 740 parts of the dissolved matter, 420 parts of the modified polyester resin 1 having a urethane and/or urea group, 160 parts of the black master batch 1 and 100 parts of ethyl acetate, and by using the bead mill, they were stirred under the following conditions: liquid feeding speed of 1.2 Kg/hr, peripheral disc speed of 10 m/sec, an amount of filling zirconia beads having 0.5 mm diameter of 80% by volume, and the number of passes of 5 times so that a dispersion solution was obtained. This was used for a pigment-wax dispersion solution.

Next, 1420 parts of the aqueous phase, 1420 parts of the pigment-wax dispersion solution, and 5 parts of an emulsion stabilizer UCAT660M (made by Sanyo Chemical Industries, Ltd.) were put into a container, and they were mixed by a TK-type homomixer (made by PRIMIX Corporation) at 9,000 rpm for 30 minutes under an ambient temperature of 28° C. so that an emulsified slurry was obtained.

The emulsified slurry was loaded into a container equipped with a stirring bar and a thermometer, and after having been subjected to a desolvent process at 35° C. for 10 hours, the slurry was matured at 45° C. for 12 hours so that a dispersion solution from which the organic solvent had been distilled off was obtained. After 100 parts of the dispersion solution had been filtered under reduced pressure, 300 parts of ion exchange water was added to the filtered cake, and after having been stirred by the TK-type homomixer at a rotation speed of 6,000 rpm for 15 minutes, the mixture was filtered under reduced pressure. Thereafter, 100 parts of a 10% aqueous solution of sodium hydroxide was added to the filtered cake, and after having been stirred by the TK-type homomixer at a rotation speed of 6,000 rpm for 15 minutes, the mixture was filtered under reduced pressure. Thereafter, 100 parts of a 10% hydrochloric acid solution was added to the filtered cake, and after having been stirred by the TK-type homomixer at a rotation speed of 6,000 rpm for 15 minutes, the mixture was filtered under reduced pressure. To the filtered cake was then added 500 parts of ion exchange water, and after having been stirred by the TK-type homomixer at a rotation speed of 6,000 rpm for 30 minutes, the mixture was filtered under reduced pressure so that a filtered cake was obtained.

The filtered cake was dried by an air dryer at 40° C. for 24 hours, and sieved by a mesh having an opening of 75 μm to prepare toner base particles, which had a weight average particle size of 5.0 μm and a ratio of weight average particle size/number average particle size of 1.13.

Next, to 100 parts by mass of the toner base particles were added 1.0 part by weight of an additive (HDK-2000, made by Clariant) and 1.0 part by weight of an additive (H05TD, made by Clariant), and they were stirred and mixed with one another by a Henschel mixer so that a black toner 2 was produced.

Moreover, the same processes as those described above were carried out except that in place of a black master batch 1, a magenta master batch 1, a cyan master batch 1 and a yellow master batch 1 were respectively used so that a magenta toner 2, a cyan toner 2 and a yellow toner 2 were manufactured, and a color toner 2, including the black toner 2, the magenta toner 2, the cyan toner 2 and the yellow toner 2, which was a toner obtained by a dissolving suspension method, was produced.

### Production Example of Color Toner 3

First, 100 parts of water, 10 parts of an aqueous dispersion solution of a vinyl-based resin (copolymer of styrene-methacrylic acid-butyl acrylate-sodium salt of an adduct of a sulfuric ester with ethyleneoxide methacrylate) (made by Sanyo Chemical Industries, Ltd., solid components: 20%), 20 parts of a 50% aqueous solution of dodecyldiphenylether sodium disulfonate (ELEMINOL MON-7, made by Sanyo Chemical Industries, Ltd.), 40 parts of a 1% aqueous solution of carboxymethylcellulose serving as a polymer protective colloid (Cellogen BSH, made by Sanyo Chemical Industries, Ltd.), and 15 parts of ethyl acetate were mixed and stirred so that a solution having a milky white color was obtained. This was used as an aqueous phase.

To a container equipped with a stirring bar and a thermometer were loaded 250 parts of a polyester resin (Tg: 64° C., Mw: 15300, Mn: 3800, Acid Value: 7 mgKOH/g, Loss Tangent Peak Temperature: 143.7° C.), 40 parts of carnauba wax and 200 parts of ethyl acetate, and they were heated to 80° C. under stirring, and after having been maintained at 80° C. for 5 hours, the mixture was cooled to 30° C. over 1 hour, and by using a bead mill (Ultra Visco Mill made by AIMEX Co., Ltd.) under the following conditions: liquid feeding speed of 1.2 Kg/hr, peripheral disc speed of 10 m/sec, an amount of filling zirconia beads having 0.5 mm diameter of 80% by volume, and the number of passes of 5 times, the wax was dispersed and a wax dispersion solution was obtained. Next, to a container equipped with a stirring bar and a thermometer were loaded 490 parts of the dissolved matter, 520 parts of the polyester resin, 160 parts of the black master batch 1 and 100 parts of ethyl acetate, and by using the bead mill, they were stirred under the following conditions: liquid feeding speed of 1.2 Kg/hr, peripheral disc speed of 10 m/sec, an amount of filling zirconia beads having 0.5 mm diameter of 80% by volume, and the number of passes of 5 times so that a dispersion solution was obtained. This was used for a pigment-wax dispersion solution.

Next, 1420 parts of the aqueous phase, 1270 parts of the pigment-wax dispersion solution, 150 parts of a 50% ethyl acetate solution of a prepolymer (number average molecular weight: 6500, Tg: 55° C., content of isolated isocyanate: 1.5% by weight, made by Sanyo Chemical Industries, Ltd.), 1 part of isobutyl alcohol, 7 parts of isophoronediamine and 5 parts of an emulsion stabilizer UCAT660M (made by Sanyo Chemical Industries, Ltd.) were put into a container, and they were mixed by a TK-type homomixer (made by Tokushu Kika Kogyo Co., Ltd.) at 9,000 rpm for 30 minutes under an ambient temperature of 28° C. so that an aqueous medium dispersion solution was obtained.

Thereafter, the aqueous medium dispersion solution was heated to 58° C., and it was further dispersed and mixed by the TK-type homomixer at a rotation speed of 1,500 rpm for 1 hour so that an emulsified slurry was obtained.

The above-mentioned emulsified slurry was loaded into a container equipped with a stirring bar and a thermometer, and after having been subjected to a desolvent process at 35° C. for 10 hours, the slurry was matured at 45° C. for 12 hours so that a dispersion solution from which the organic solvent had been distilled off was obtained. After 100 parts of the dispersion solution had been filtered under reduced pressure, 300 parts of ion exchange water was added to the filtered cake, and after having been stirred by the TK-type homomixer at a rotation speed of 6,000 rpm for 15 minutes, the mixture was filtered under reduced pressure. Thereafter, 100 parts of a 10% aqueous solution of sodium hydroxide was added to the filtered cake, and after having been stirred by the TK-type homomixer at a rotation speed of 6,000 rpm for 15 minutes, the mixture was filtered under reduced pressure. Thereafter, 100 parts of a 10% hydrochloric acid solution was added to the filtered cake, and after having been stirred by the TK-type homomixer at a rotation speed of 6,000 rpm for 15 minutes, the mixture was filtered under reduced pressure. Thereafter, 500 parts of ion-exchange water was added to the filtered cake and mixed by the TK-type homomixer at a rotation speed of 6,000 rpm for 30 minutes, and the mixture was filtered under reduced pressure so that a filtered cake was obtained.

The filtered cake was dried by an air dryer at 40° C. for 24 hours, and sieved by a mesh having an opening of 75 μm to prepare toner base particles, which had a weight average particle size of 5.2 μm and a ratio of weight average particle size/number average particle size of 1.14.

Next, to 100 parts by mass of the toner base particles were added 1.0 part by weight of an additive (HDK-2000, made by Clariant) and 1.0 part by weight of an additive (H05TD, made by Clariant), and the mixture was stirred and mixed with one another by a Henschel mixer so that a black toner 3 was produced.

Moreover, the same processes as those described above were carried out except that in place of a black master batch 1, a magenta master batch 1, a cyan master batch 1 and a yellow master batch 1 were respectively used so that a magenta toner 3, a cyan toner 3 and a yellow toner 3 were manufactured, and a color toner 3, including the black toner 3, the magenta toner 3, the cyan toner 3 and the yellow toner 3, which was a toner obtained by a polyester extension method, was produced.

### Production Example of Color Toner 4

First, 100 parts of water, 10 parts of an aqueous dispersion solution of a vinyl-based resin (copolymer of styrene-methacrylic acid-butyl acrylate-sodium salt of an adduct of a sulfuric ester with ethyleneoxide methacrylate) (made by Sanyo Chemical Industries, Ltd., solid components: 200), 20 parts of a 50% aqueous solution of dodecyldiphenylether sodium disulfonate (ELEMINOL MON-7, made by Sanyo Chemical Industries, Ltd.), 40 parts of a 1% aqueous solution of carboxymethylcellulose serving as a polymer protective colloid (Cellogen BSH, made by Sanyo Chemical Industries, Ltd.), and 15 parts of ethyl acetate were mixed and stirred so that a solution having a milky white color was obtained. This was used as an aqueous phase.

To a container equipped with a stirring bar and a thermometer were loaded 230 parts of a polyester resin (Tg: 59° C., Mw: 10800, Mn: 2800, Acid Value: 8 mgKOH/g, Loss Tangent Peak Temperature: 129.6° C.), 20 parts of a crystalline polyester resin (softening point: 95° C.), 40 parts of carnauba wax and 200 parts of ethyl acetate, and they were heated to 80° C. under stirring, and after having been maintained at 80° C. for 5 hours, the mixture was cooled to 30° C. over 1 hour, and by using a bead mill (Ultra Visco Mill made by AIMEX Co., Ltd.) under the following conditions: liquid feeding speed of 1.2 Kg/hr, peripheral disc speed of 10 m/sec, an amount of filling zirconia beads having 0.5 mm diameter of 80% by volume, and the number of passes of 5 times, the wax was dispersed and a wax dispersion solution was obtained. Next, to a container equipped with a stirring bar and a thermometer were loaded 490 parts of the dissolved matter, 470 parts of the polyester resin, 50 parts of the crystalline polyester resin (softening point: 95° C.), 160 parts of the black master batch 1 and 100 parts of ethyl acetate, and by using the bead mill, they were stirred under the following conditions: liquid feeding speed of 1.2 Kg/hr, peripheral disc speed of 10 m/sec, an amount of filling zirconia beads having 0.5 mm diameter of 80% by volume, and the number of passes of 5 times so that a dispersion solution was obtained. This was used for a pigment-wax dispersion solution.

Next, 1420 parts of the aqueous phase, 1270 parts of the pigment-wax dispersion solution, 150 parts of a 50% ethyl acetate solution of a prepolymer (number average molecular weight: 6500, Tg: 55° C., content of isolated isocyanate: 1.5% by weight, made by Sanyo Chemical Industries, Ltd.), 1 part of isobutyl alcohol, 7 parts of isophoronediamine and 5 parts of an emulsion stabilizer UCAT660M (made by Sanyo Chemical Industries, Ltd.) were put into a container, and they were mixed by a TK-type homomixer (made by PRIMIX Corporation) at 9,000 rpm for 30 minutes under an ambient temperature of 28° C. so that an aqueous medium dispersion solution was obtained.

Thereafter, the aqueous medium dispersion solution was heated to 58° C., and it was further dispersed and mixed by the TK-type homomixer at a rotation speed of 1,500 rpm for 1 hour so that an emulsified slurry was obtained.

The above-mentioned emulsified slurry was loaded into a container equipped with a stirring bar and a thermometer, and after having been subjected to a desolvent process at 35° C. for 10 hours, the slurry was matured at 45° C. for 12 hours so that a dispersion solution from which the organic solvent had been distilled off was obtained. After 100 parts of the dispersion solution had been filtered under reduced pressure, 300 parts of ion exchange water was added to the filtered cake, and after having been stirred by the TK-type homomixer at a rotation speed of 6,000 rpm for 15 minutes, the mixture was filtered under reduced pressure. Thereafter, 100 parts of a 10% aqueous solution of sodium hydroxide was added to the filtered cake, and after having been stirred by the TK-type homomixer at a rotation speed of 6,000 rpm for 15 minutes, the mixture was filtered under reduced pressure. Thereafter, 100 parts of a 10% hydrochloric acid solution was added to the filtered cake, and after having been stirred by the TK-type homomixer at a rotation speed of 6,000 rpm for 15 minutes, the mixture was filtered under reduced pressure. Thereafter, 500 parts of ion-exchange water was added to the filtered cake and mixed by the TK-type homomixer at a rotation speed of 6,000 rpm for 30 minutes, and the mixture was filtered under reduced pressure so that a filtered cake was obtained.

The filtered cake was dried by an air dryer at 40° C. for 24 hours, and sieved by a mesh having an opening of 75 μm to prepare toner base particles, which had a weight average particle size of 5.2 μm and a ratio of weight average particle size/number average particle size of 1.14.

Next, to 100 parts by mass of the toner base particles were added 1.0 part by weight of an additive (HDK-2000, made by Clariant) and 1.0 part by weight of an additive (H05TD, made by Clariant), and the mixture was stirred and mixed with one another by a Henschel mixer so that a black toner 4 was produced.

Moreover, the same processes as those described above were carried out except that in place of a black master batch 1, a magenta master batch 1, a cyan master batch 1 and a yellow master batch 1 were respectively used so that a magenta toner 4, a cyan toner 4 and a yellow toner 4 were manufactured, and a color toner 4, including the black toner 4, the magenta toner 4, the cyan toner 4 and the yellow toner 4, which was a toner obtained by a polyester extension method, was produced.

### Production Example of Color Toner 5

| | |
|---|---|
| Polyester resin | 92 parts by weight |
| (Tg: 64° C., Mw: 15300, Mn: 3800, AcidValue: | |
| 7 mgKOH/g, Loss Tangent Peak Temperature: | |
| 143.7° C.) | |
| Crystalline polyester resin (Softening point: 70° C.) | 15 parts by weight |
| Carnauba wax | 4 parts by weight |
| (Carnauba Wax No. 1, made by Cerarica Noda | |
| Co., Ltd.) | |
| Ethylene-bis-stearic acid amide | 2 parts by weight |
| (EB-P, made by Kao Corporation) | |
| Black master batch 1 | 16 parts by weight |

The same processes as those of the transparent toner 1 were carried out except that the above-mentioned toner raw materials were used so that a black toner 5 was produced.

Moreover, the same processes as those described above were carried out except that in place of a black master batch 1, a magenta master batch 1, a cyan master batch 1 and a yellow master batch 1 were respectively used so that a magenta toner 5, a cyan toner 5 and a yellow toner 5 were manufactured, and a color toner 5 including the black toner 5, the magenta toner 5, the cyan toner 5 and the yellow toner 5 was produced.

### Production Example of Two-Component Developer

Each of 5% by mass of the transparent toner and the color toner produced and 95% by mass of a coated ferrite carrier were uniformly mixed at 48 rpm for 5 minutes by using a turbular mixer (made by Willy A. Bachofen (WAB) AG) so as to be charged; thus, two-component developers were respectively produced.

### Examples and Comparative Examples

Next, by using an image-forming method 1 and an image-forming method 2, printing processes of the transparent toner and colored toners were carried out.

### <Gloss Degree>

Exposing, developing and transferring processes were carried out so as to make a solid image of the transparent toner having an amount of adhesion of 0.4 mg/cm² superposed on a solid image of the color toner having an amount of adhesion of 0.4 mg/cm², and after having been fixed at a fixing linear velocity of 160 mm/sec at a fixing temperature of 190° C., with a NIP width of 11 mm, the gloss degree was measured on the resulting image.

At this time, POD gloss coat paper 128 g/m², made by Oji Paper Co., Ltd., was used as the paper to be evaluated. The gloss was measured by using a gloss meter VGS-1D, made by Nippon Denshoku Industries Co., Ltd., and the image was evaluated at 10 points in gloss at 60° C.; thus, an average gloss of 85 or more was evaluated as ⊙, an average gloss from 80 to less than 85 was evaluated as ◯, an average gloss from 50 to less than 80 was evaluated as Δ, and an average gloss of 50 or less was evaluated as x.

### <Non-Offset Width>

With an amount of adhesion of toner being set to 0.8 mg/cm², fixing processes were carried out at a linear velocity of 160 mm/sec by using PPC paper TYPE 6000 (70W) made by Ricoh Co., Ltd., while the fixing temperature was changed for every 5° C.; thus, a temperature width in which no offset occurred was confirmed.

### <Preservability>

In preservability evaluation, each of 10 g of toners was put into a screw vial bottle (30 ml), and after having been subjected to tapping processes of 100 times by using a tapping machine, it was kept in a thermostatic chamber at 45° C. for 24 hours, and then returned to room temperature, and subjected to measurements on a needle-insertion degree by using a needle-insertion degree test machine. In the case of a needle insertion degree of 10 mm or less, the toner was evaluated as x, in the case of 10 mm or more, the toner was evaluated as ◯, and in the case of 15 mm or more, the toner was evaluated as ⊙.

Table 1 shows the Loss Tangent Peak temperature (° C.), the loss tangent temperature value and the non-offset temperature width of each of the transparent toners.

TABLE 1

| | tanδ | | Non-Offset | |
|---|---|---|---|---|
| | Maximum Peak | tanδ | Temperature | Toner |
| Toner | Temperature | Value | Width | Preservability |
| Transparent | 156 | 11 | 70 | ◯ |
| Toner 1 | | | | |
| Transparent | 117 | 7 | 60 | ◯ |
| Toner 2 | | | | |
| Transparent | 85 | 5 | 50 | ◯ |
| Toner 3 | | | | |
| Transparent | 96 | 6 | 60 | ◯ |
| Toner 4 | | | | |
| Transparent | 145 | 8 | 60 | ◯ |
| Toner 5 | | | | |
| Transparent | No Peaks | — | 60 | ◯ |
| Toner 6 | | | | |
| Transparent | 78 | 4 | 25 | X |
| Toner 7 | | | | |
| Transparent | 122 | 10 | 50 | ◯ |
| Toner 8 | | | | |
| Transparent | 154 | 9 | 70 | ⊙ |
| Toner 9 | | | | |
| Transparent | 116 | 6 | 60 | ⊙ |
| Toner 10 | | | | |
| Transparent | 117 | 7 | 60 | ⊙ |
| Toner 11 | | | | |
| Transparent | 116 | 6 | 55 | ⊙ |
| Toner 12 | | | | |
| Transparent | 165 | 32 | 60 | ◯ |
| Toner 13 | | | | |
| Transparent | 148 | 22 | 30 | ◯ |
| Toner 14 | | | | |
| Color Toner 1 | No Peaks | — | 60 | ◯ |
| Color Toner 2 | 120 | 2 | 50 | ◯ |
| Color Toner 3 | 145 | 7 | 60 | ◯ |
| Color Toner 4 | 128 | 4 | 55 | ◯ |
| Color Toner 5 | 116 | 4 | 60 | ◯ |

### Example 1

By using the image-forming method 1 with the use of the transparent toner 1 and the color toner 1, an image was formed, and a fixed image was obtained. The gloss of a portion bearing the transparent toner was 81 so that high gloss was obtained. The gloss of a color toner portion was 50 or less.

### Example 2

By using the image-forming method 1 with the use of the transparent toner 3 and the color toner 2, an image was formed, and a fixed image was obtained. The gloss of a portion bearing the transparent toner was 83 so that high gloss was obtained. The gloss of a color toner portion was 50 or less.

### Example 3

By using the image-forming method 2 with the use of the transparent toner 4 and the color toner 3, an image was formed, and a fixed image was obtained. The gloss of a portion bearing the transparent toner was 80 so that high gloss was obtained. The gloss of a color toner portion was in a range from 50 to less than 80. At this time, no offset was generated by the image-forming method 2.

### Example 4

By using the image-forming method 2 with the use of the transparent toner 5 and the color toner 1, an image was formed, and a fixed image was obtained. The gloss of a portion bearing the transparent toner was 81 so that high gloss was obtained. The gloss of a color toner portion was in a range from 50 to less than 80. At this time, no offset was generated by the image-forming method 2.

### Example 5

By using the image-forming method 1 with the use of the transparent toner 2 and the color toner 5, an image was formed, and a fixed image was obtained. The gloss of a portion bearing the transparent toner was 80 so that high gloss was obtained. The gloss of a color toner portion was 82 so that an image having high gloss over the entire surface was obtained.

### Example 6

By using the image-forming method 2 with the use of the transparent toner 4 and the color toner 4, an image was formed, and a fixed image was obtained. The gloss of a portion bearing the transparent toner was 80 so that high gloss was obtained. The gloss of a color toner portion was in a range from 50 to less than 80. At this time, no offset was generated by the image-forming method 2.

### Example 7

By using the image-forming method 1 with the use of the transparent toner 8 and the color toner 1, an image was formed, and a fixed image was obtained. The gloss of a portion bearing the transparent toner was 85 or more so that high gloss was obtained. The gloss of a color toner portion was 50 or less. At this time, no offset was generated by the image-forming method 1.

### Example 8

By using the image-forming method 1 with the use of the transparent toner 9 and the color toner 5, an image was formed, and a fixed image was obtained. The gloss of a portion bearing the transparent toner was 84 so that high gloss was obtained. The gloss of a color toner portion was 80 so that an image having high gloss over the entire surface was obtained. At this time, no offset was generated by the image-forming method 1.

### Example 9

By using the image-forming method 1 with the use of the transparent toner 10 and the color toner 5, an image was formed, and a fixed image was obtained. The gloss of a portion bearing the transparent toner was 85 or more so that high gloss was obtained. The gloss of a color toner portion was 81 so that an image having high gloss over the entire surface was obtained. At this time, no offset was generated by the image-forming method 1.

### Example 10

By using the image-forming method 1 with the use of the transparent toner 11 and the color toner 5, an image was formed, and a fixed image was obtained. The gloss of a portion bearing the transparent toner was 85 or more so that high gloss was obtained. The gloss of a color toner portion was 80 so that an image having high gloss over the entire surface was obtained. At this time, no offset was generated by the image-forming method 1.

### Example 11

By using the image-forming method 1 with the use of the transparent toner 12 and the color toner 5, an image was formed, and a fixed image was obtained. The gloss of a portion bearing the transparent toner was 85 or more so that high gloss was obtained. The gloss of a color toner portion was 81 so that an image having high gloss over the entire surface was obtained. At this time, no offset was generated by the image-forming method 1.

### Comparative Example 1

By using the image-forming method 1 with the use of the transparent toner 6 and the color toner 5, an image was formed, and a fixed image was obtained. The gloss of a portion bearing the transparent toner was 50 or less, and the gloss of a color toner portion was 80, with the result that the image had low gloss at a portion bearing the transparent toner, with differences in gloss.

### Comparative Example 2

By using the image-forming method 1 with the use of the transparent toner 6 and the color toner 1, an image was formed, and a fixed image was obtained. The gloss of both of portions bearing the transparent toner and the color toner was 50 or less, failing to provide high gloss.

### Comparative Example 3

By using the image-forming method 1 with the use of the transparent toner 7 and the color toner 1, an image was formed, and a fixed image was obtained. The gloss of a portion bearing the color toner was 81 or more, so that high gloss was obtained.

The gloss of a color toner portion was 50 or less. Moreover, it was poor in preservability and the degree of needle insertion became x. At this time, it was acknowledged that an offset was generated by the image-forming method 1.

### Comparative Example 4

By using the image-forming method 1 with the use of the transparent toner 6 and the color toner 1, an image was formed, and a fixed image was obtained. The gloss of a portion bearing the transparent toner was in a range from 50 to less than 80, and the gloss of a color toner portion was 50 or less, with the result that the image had low gloss as a whole. At this time, no offset was generated by the image-forming method 2.

### Comparative Example 5

By using the image-forming method 1 with the use of the transparent toner 13 and the color toner 1, an image was formed, and a fixed image was obtained. The gloss of a portion bearing the transparent toner was in a range from 50 to less than 80, and the gloss of a color toner portion was 50 or less, with the result that the image had low gloss as a whole. At this time, no offset was generated by the image-forming method 1.

### Comparative Example 6

By using the image-forming method 1 with the use of transparent toner 14 and color toner 1, an image was formed, and a fixed image was obtained. The gloss of a portion bearing the transparent toner was in a range from 50 to less than 80, and the gloss of a color toner portion was 50 or less, with the result that the image had low gloss as a whole. At this time, it was acknowledged that an offset was generated by the image-forming method 1.

The above results are summarized in the following table.

TABLE 2

| | | | | | Gloss of | |
|---|---|---|---|---|---|---|
| | | | | Image- | Transparent | Gloss of Color |
| | Transparent Toner | | Colored | Forming | Toner | Toner |
| | Toner No. | Method | Toner | Method | Portion | Portion |
| Example 1 | Transparent | Pulverized | Color | 1 | ◯ | X |
| | Toner 1 | | Toner 1 | | | |
| Example 2 | Transparent | Pulverized | Color | 1 | ◯ | X |
| | Toner 3 | | Toner 2 | | | |
| Example 3 | Transparent | Pulverized | Color | 2 | ◯ | Δ |
| | Toner 4 | | Toner 3 | | | |
| Example 4 | Transparent | Dissolved | Color | 2 | ◯ | Δ |
| | Toner 5 | and | Toner 1 | | | |
| | | Suspended | | | | |
| Example 5 | Transparent | Pulverized | Color | 1 | ◯ | ◯ |
| | Toner 2 | | Toner 5 | | | |
| Example 6 | Transparent | Pulverized | Color | 2 | ◯ | Δ |
| | Toner 4 | | Toner 4 | | | |
| Example 7 | Transparent | Pulverized | Color | 1 | ⊙ | Δ |
| | Toner 8 | | Toner 1 | | | |
| Example 8 | Transparent | Pulverized | Color | 1 | ◯ | ◯ |
| | Toner 9 | | Toner 5 | | | |
| Example 9 | Transparent | Pulverized | Color | 1 | ⊙ | ◯ |
| | Toner 10 | | Toner 5 | | | |
| Example 10 | Transparent | Pulverized | Color | 1 | ⊙ | ◯ |
| | Toner 11 | | Toner 5 | | | |
| Example 11 | Transparent | Pulverized | Color | 1 | ⊙ | ◯ |
| | Toner 12 | | Toner 5 | | | |
| Comparative | Transparent | Pulverized | Color | 1 | X | ◯ |
| Example 1 | Toner 6 | | Toner 5 | | | |
| Comparative | Transparent | Pulverized | Color | 1 | X | X |
| Example 2 | Toner 6 | | Toner 1 | | | |
| Comparative | Transparent | Pulverized | Color | 1 | ◯ | X |
| Example 3 | Toner 7 | | Toner 1 | | | |
| Comparative | Transparent | Pulverized | Color | 2 | Δ | X |
| Example 4 | Toner 6 | | Toner 1 | | | |
| Comparative | Transparent | Pulverized | Color | 1 | Δ | X |
| Example 5 | Toner13 | | Toner 1 | | | |
| Comparative | Transparent | Pulverized | Color | 1 | ◯ | X |
| Example 6 | Toner14 | | Toner 1 | | | |

This application claims priority and contains subject matter related to Japanese Patent Applications Nos. 2009-234071, 2010-193956, and 2009-230126, filed on Oct. 8, 2009, Aug. 31, 2010 and Oct. 2, 2009, respectively, the entire contents of each of which are hereby incorporated by reference.

Having row fully described the invention, it will be apparent to one of ordinary skill in the art that many changes and modifications can be made thereto without departing from the scope of the invention as set forth therein.

What is claimed as new and desired to be secured by Letters Patent of the United States is:

1. A transparent toner for use in an electrophotographic image forming method of forming an image on a recording medium with one or more chromatic toners and the transparent toner, comprising:
a thermoplastic resin; and
a lubricant,
wherein the transparent toner has a tangent loss (tan δ) determined by the following formula having a maximum peak value not less than 3 in a range of from 80 to 160° C.:
tangent loss (tan δ)=loss elastic modulus (G″) of the transparent toner/storage elastic modulus (G′) thereof.

2. The transparent toner of claim 1, wherein the thermoplastic resin comprises a polyester resin having a ratio (Mw/Mn) of a weight-average molecular weight (Mw) thereof to a number-average molecular weight (Mn) thereof not greater than 6.

3. The transparent toner of claim 1, further comprising a crystalline polyester resin.

4. The transparent toner of claim 1, wherein the lubricant comprises a fatty acid amide lubricant.

5. The transparent toner of claim 1, wherein the transparent toner is prepared by a solution suspension method.

6. The transparent toner of claim 1, wherein the chromatic toner is prepared by a solution suspension method.

7. The transparent toner of claim 1, wherein the chromatic toner comprises a crystalline polyester resin.

8. The transparent toner of claim 1, wherein the one or more chromatic toners comprise:
a thermoplastic resin; and
a lubricant,
wherein the chromatic toner has a tangent loss (tan δ) determined by the following formula having a maximum peak value not less than 3 in a range of from 80 to 160° C.:
tangent loss (tan δ)=loss elastic modulus (G″) of the transparent toner/storage elastic modulus (G′) thereof.

9. An image forming apparatus forming an image with one or more chromatic toners and a transparent toner, comprising:
a photoreceptor;
a charger configured to charge the photoreceptor;
an irradiator configured to irradiate the photoreceptor to form an electrostatic latent image thereon;
an image developer configured to develop the electrostatic latent image with a developer comprising the transparent or the chromatic toner according to claim 1 to form a transparent toner image or a chromatic toner image;
a transferer configured to transfer the transparent toner image or the chromatic toner image onto a recording medium; and
a fixer configured to fix the transparent toner image or the chromatic toner image on the recording medium,
wherein the image forming apparatus fixing one chromatic toner image on a recording medium and a transparent toner image on the chromatic toner image in a first image formation, and forming another chromatic toner image on the recording medium in a second image formation.

10. The image forming apparatus of claim 9, wherein the developer is a two-component developer further comprising a carrier.

11. The image forming apparatus of claim 9, wherein the transparent toner image is formed on the chromatic toner image and has a thickness of from 1 to 15 μm.

12. The image forming apparatus of claim 9, further comprising a device configured to detect a registration position gap and adjust a data writing position in the second image formation.

13. The image forming apparatus of claim 9, wherein the transparent toner image is transferred onto the chromatic toner image after the chromatic toner image is transferred onto the recording medium.
